(19) United States
(12) Patent Application Publication
(10) Pub. No.: US 2009/0260008 A1
(43) Pub. Date: Oct. 15, 2009

(54) VIRTUAL MACHINE MANAGEMENT SYSTEM AND METHOD FOR MANAGING PROCESSOR RESOURCES THEREOF

(76) Inventors: Seung-mo CHO, Seoul (KR); Hyeon-seung JANG, Seoul (KR)

Correspondence Address: MCNEELY BODENDORF LLP, P.O. BOX 34175, WASHINGTON, DC, 20043, US

(21) Appl. No.: 12/411,416

(22) Filed: Mar. 26, 2009

(30) Foreign Application Priority Data
Apr. 14, 2008 (KR) 10-2008-0034190

(51) Int. Cl. G06F 9/455

(52) U.S. Cl. 718/1

(57) ABSTRACT

A virtual machine management system, the system including: at least one virtual machine to request a processor to drive a software application or component, and a virtual machine monitor to determine whether allocating the requested processor is possible, to create a waiting list if the allocating of the requested processor is determined to not be possible, and to allocate an obtained processor according to the waiting list. Accordingly, the processor is dynamically allocated and the processor resources are efficiently utilized.

### CROSS-REFERENCE TO RELATED APPLICATION

This application claims the benefit of Korean Patent Application No. 2008-34190, filed Apr. 14, 2008 in the Korean Intellectual Property Office, the entire disclosure of which is incorporated herein by reference.

### BACKGROUND

1. Field

Aspects of the present invention relate to a virtual machine management system and a method of managing processor resources thereof and, more particularly, to a virtual machine management system that efficiently allocates processors to a plurality of virtual machines, and a method of managing processor resources thereof.

2. Description of the Related Art

Recently, many computer systems have begun to use a multi-processor structure to support a wide range of application software and to process a huge amount of data. The multi-processor structure is largely divided into a symmetric multiprocessing (SMP) that uses a plurality of homogeneous processors and allows the plurality of homogeneous processors to perform the same work and an asymmetric multiprocessing (AMP) that uses a plurality of heterogeneous processors.

The AMP system realizes a virtual environment using general purpose processors that execute an operating system and a general application program under the operating system, and dedicated processors that execute specialized programs. In the AMP system, processor resources are allocated in a static allocation scheme or a scheduling scheme using a virtual machine monitor (VMM).

According to the static allocation scheme, a VMM allocates dedicated processors, which are pre-defined in number and configuration, to respective virtual machines. Accordingly, the virtual machines cannot share a processor and, even if a first virtual machine does not use a dedicated processor allocated thereto, a second virtual machine cannot use the processor. Therefore, there is a problem of reduced availability of processors in view of the entire system.

According to the scheduling method by the VMM, regardless of how the processors are allocated, it is determined whether there is a request for use of a dedicated processor from the virtual machines and the virtual machines share the processor, and the VMM performs a scheduling with respect to respective virtual machines. Therefore, there is a problem that a scheduler code that has been created suitably for a guest operating system characteristic of each virtual machine is useless.

### SUMMARY

Aspects of the present invention provide a virtual machine management system that dynamically allocates processors to a plurality of virtual machines, thereby utilizing processor resources efficiently, and a method of managing processor resources thereof.

According to an aspect of the present invention, there is provided a method of managing processor resources of a virtual machine monitor, the method including: receiving a request for allocation of a processor from at least one virtual machine: determining whether it is possible to allocate the requested processor; and if it is not possible to allocate the requested processor, creating a waiting list, and if a processor is obtained, allocating the obtained processor according to the waiting list.

The creating of the waiting list may include, if it is not possible to allocate the processor, creating a waiting list for the at least one virtual machine that has requested the allocation based on a pre-set processor allocation priority order, and requesting another virtual machine to return an occupied processor.

The method may further include allocating the processor that has returned in response to the request to a virtual machine corresponding to a priority of the created waiting list.

The method may further include, if there is no response to the request for return of the processor, terminating allocation of the processor and allocating the terminated processor to a virtual machine corresponding to a priority of the created waiting list.

The method may further include receiving an inquiry about a reusability of the processor from the virtual machine, and if the processor is reusable, maintaining the allocating of the processor, and if the processor is not reusable, requesting return of the processor.

The method may further include, if the processor is returned, terminating a use of the processor and adding the virtual machine to the waiting list.

The determining of whether it is possible to allocate the requested processor may include determining whether it is possible to allocate the processor according to a number of processors available, a number of processor currently occupied, and/or a number of total processors in a system.

According to another aspect of the present invention, there is provided a method of managing processor recourses of a virtual machine, the method including: requesting a virtual machine monitor to allocate a processor; scheduling a software application or component using the processor allocated by the request; if use of the allocated processor terminates, determining whether to reuse the processor; and if the processor is to be reused, inquiring about whether the processor should be returned.

According to another aspect of the present invention, there is provided a virtual machine management system, the system including: at least one virtual machine to request a processor to drive a software application or component; and a virtual machine monitor to determine whether it is possible to allocate the requested processor, if the processor allocation is not possible, to create a waiting list, and if a processor is obtained, to allocate the obtained processor according to the waiting list.

If the processor allocation is determined to not be possible, the virtual machine monitor may create a waiting list of the at least one virtual machine that has requested the allocation, based on a pre-set processor allocation priority order.

The virtual machine monitor may request another virtual machine to return an occupied processor and allocate the processor returned by the request to a virtual machine according to a priority of the created waiting list.

The at least one virtual machine may determine whether the processor after termination of use is reusable, and if the processor is to be reused, may inquire of the virtual machine monitor about whether the processor should be returned.

If the processor is to be returned, the virtual machine monitor may terminate the use of the processor and add the virtual machine to the waiting list.

The virtual machine monitor may determine whether it is possible to allocate the processor according to a number of processors available, a number of processors currently occupied, and a number of total processors in the system.

The processor may be a dedicated processor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a virtual machine management system according to an embodiment of the present invention;

FIG. 2 is a flowchart illustrating a method of managing processor resources of a virtual machine monitor according to an embodiment of the present invention;

FIG. 3 is a flowchart illustrating a method of managing processor resources of a virtual machine monitor according to another embodiment of the present invention; and

FIG. 4 is a flowchart illustrating a method of managing processor resources of a virtual machine according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

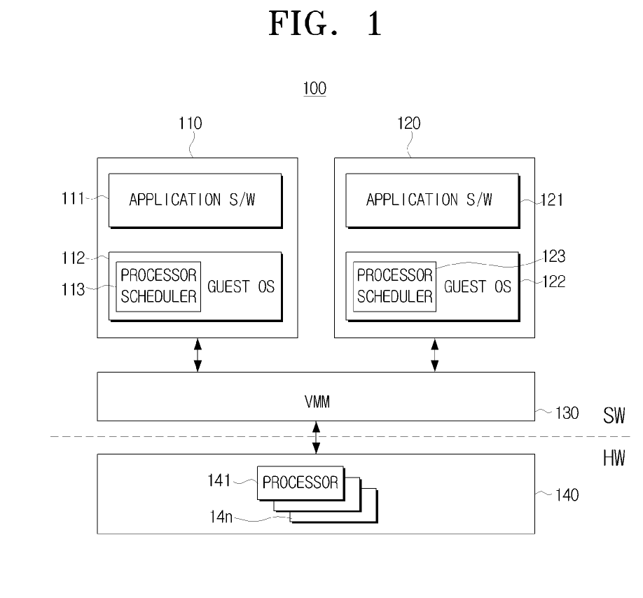

FIG. 1 is a block diagram illustrating a virtual machine management system 100 according to an embodiment of the present invention. Referring to FIG. 1, a virtual machine management system 100 is a computing system to realize a virtual environment and includes a virtual machine monitor (VMM) 130 and a plurality of virtual machines 110, 120.

The virtual machine monitor 130 may be executed on a computer and provides abstraction of one or more virtual machines 110, 120 to another software application or component. The virtual machines 110, 120 operate as a self-contained platform to execute respective guest operating systems (OS) 112, 122 and respective application software 111, 121. The guest operating systems 112, 122 are operated as if the guest operating systems 112, 122 are executed on dedicated computers. That is, the guest operating systems 112, 122 control various computer operations and, during these operations, processor schedulers 113, 123 access hardware resources of a hardware unit 140. The hardware resources may be resources of processors 141 to 14n. The processor schedulers 113, 123 load the processors and execute the application software 111, 121.

In order to efficiently allocate processor resources to the virtual machines 110, 120 and provide protection between the virtual machines 110, 120 in the virtual environment, the virtual machine monitor 130 may perform dynamic processor resource allocation and return with respect to the respective virtual machines 110, 120. Accordingly, an interface to allocate and return processor resources between the virtual machine monitor 130 and the virtual machines 110, 120 can be defined as follows to allow the processor resources to be distributed efficiently:

TABLE 1

| | |
|---|---|
| Int h_alloc_proc(spec); | Request for processor allocation |
| Int h_return_proc(proc_id); | Request for processor return |
| Int h_can_keep_proc(proc_id) | Inquiry of reuse of processor |
| VIRQ_PROC_AVAIL | Notify presence of available processor |
| VIRQ_PROC_NEEDED | Request for processor return |

According to the above table 1, command transmission from the virtual machines 110, 120 to the virtual machine monitor 130 is processed as a hypercall, and command transmission from the virtual machine monitor 130 to the virtual machines 110, 120 is defined as a virtual interrupt and realized. Operation of the virtual machine management system 100 using the interface according to table 1 will now be described in detail.

If the virtual machines 110, 120 are to drive the application software, the virtual machines 110, 120 request the virtual machine monitor 130 to allocate a processor. For example, in the first virtual machine 110, the application software 111 requests the guest operating system 112 to allocate a processor for execution.

The processor scheduler 113 determines whether an additional processor is to be used. If an additional processor is to be used, the processor scheduler 113 requests the virtual machine monitor 130 to allocate a processor as the additional processor. The request for processor allocation may include preferred non-uniform memory accesses (NUMA) node information. In this case, since the request is made for allocation of a processor that is easy to access, time taken to make a request and time taken to respond to the request can be shortened. Furthermore, the processor requested to be allocated may be a dedicated processor to drive specialized application software.

The virtual machine monitor 130 determines whether it is possible to allocate a processor to the virtual machine 110 based on an allocation policy. The number of processors available in the virtual machine 110, the number of processors occupied by the virtual machine 110, and/or the number of total processors of the system may be considered by the virtual machine monitor 130 in determining whether it is possible to allocate a processor. The system operator may set the minimum number of available processors, the maximum number of available processors, a priority order, and/or configuration information for executing the specialized application software 111, 121, in association with the virtual machines 110, 120 at an initial setting time of the system or during operation.

The allocation policy is a criterion to determine whether it is possible to allocate a processor using, for example, information set by the system operator and a current state of the virtual machine. For example, the allocation policy provide the following criteria:

1. Each of the virtual machines 110, 120 is able to use a maximum number of processors at the same time;

2. A minimum number of processors can be always allocated by the virtual machine monitor 130.

3. A processor can be allocated based on a priority order or a waiting queue;

4. If the number of processors allocated to one of the virtual machines 110, 120 is greater than the maximum number of processors, the allocation is rejected;

5. If there is no processor that can be allocated, a virtual machine that occupies a processor but has a low priority order is requested to return the processor. However, if the number of processors used in the virtual machine of low priority order is less than the minimum number, the virtual machine does not return the processor; and

6. When a new virtual machine is driven and the minimum number of processors is to be set, a processor is allocated to the new virtual machine only if a sum of the minimum number of processors of at least one driving virtual machine other than the new virtual machine is less than the number of total processors in the system.

The above allocation policy is merely a non-limiting example and it is understood that other variants can be realized by the system operator. The virtual machine monitor 130 creates a waiting list if the processor allocation is not possible. If the processor is obtained, the virtual machine monitor 130 allocates the obtained processor according to the waiting list. Herein, the waiting list may be created based on the priority order set by the system operator and based on the processor allocation request order.

In order to obtain a processor to allocate, the virtual machine monitor 130 requests another virtual machine 120 to return a processor occupied by the other virtual machine 120. If the other virtual machine 120 returns the processor in response to the return request, the returned processor is allocated to the virtual machine 110 given the priority in the waiting list.

On the other hand, if there is no response to the return request, the other virtual machine 120 terminates use of the processor in a forced way based on the allocation policy. In this case, the returned processor is allocated to the virtual machine 110 according to the waiting list and the other virtual machine 120 is added to the waiting list after the forced termination.

Meanwhile, when the use of the processor allocated to the virtual machine 110 terminates, the virtual machine 110 determines whether to reuse the processor. If the reuse of the processor is determined, the virtual machine 110 inquires of the virtual machine monitor 130 as to whether the processor should be returned.

If the return of the processor is to be done, the virtual machine monitor 130 terminates the use of the processor of the virtual machine 110 and adds the virtual machine 110 to the waiting list. Furthermore, if the reuse of the processor is possible, the virtual machine monitor 130 keeps allocating the processor to the virtual machine 110. Accordingly, the virtual machine monitor 130 is able to dynamically allocate the processor to the plurality of virtual machines 110, 120.

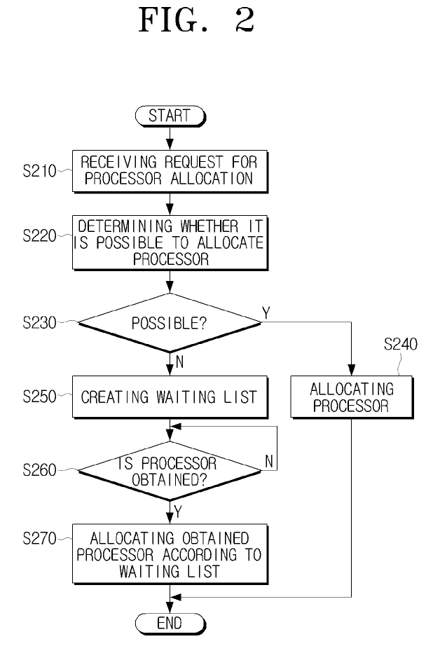

FIG. 2 is a flowchart illustrating a method of managing processor resources of a virtual machine monitor according to an embodiment of the present invention. Referring to FIG. 2, a request for processor allocation is received from at least one virtual machine in operation S210. In response to the request, it is determined whether it is possible to allocate a processor based on an allocation policy in operation S220. Examples of the allocation policy were described above with reference to FIG. 1 and are therefore omitted herein.

If it is possible to allocate a processor (operation S230), an available processor is allocated to the virtual machine that has requested the processor allocation in operation S240. On the other hand, if it is impossible to allocate a processor (operation S230), a waiting list including the virtual machine that has requested the processor allocation is created in operation S250. The waiting list determines a waiting queue according to a processor allocation request order and/or a priority order pre-set by the system operator.

If a processor that can be allocated is obtained in operation S260, the virtual machine listed in the waiting list is informed that there is a processor that can be allocated. Then, if the virtual machine requests a processor allocation, the obtained processor is allocated to the virtual machine according to the waiting queue of the waiting list such that the virtual machine is realized along with a dedicated program. The processor that can be allocated is obtained as a result of requesting another virtual machine to return a processor or returning a processor after termination of use of the processor by another virtual machine.

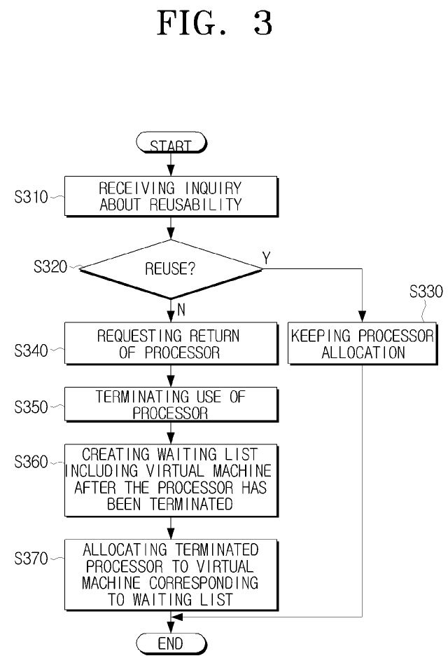

FIG. 3 is a flowchart illustrating a method of managing processor resources of a virtual machine monitor according to another embodiment of the present invention. Referring to FIG. 3, an inquiry about reuse of a processor is received from a virtual machine after termination of use in operation S310. The operation S310 may be performed, for example, after the operations S240 and S270 illustrated in FIG. 2. It is determined whether it is possible to reuse the processor of the virtual machine in question by checking a processor use condition of the virtual machine in the system 100 based on the allocation policy in operation S320.

Next, if it is determined that the reuse of the processor is possible, the processor allocation to the requested virtual machine is maintained in operation S330. Conversely, if the reuse of the processor is not to be done due to a processor allocation request from another virtual machine, the virtual machine that has requested the reuse of the processor is requested to return the processor in operation S340.

Next, if a return response to the return request is received from the virtual machine that has requested the reuse of the processor, the use of the processor terminates in operation S350. Even if there is no return response, the use of the processor may be terminated in a forced way. The waiting list is re-created, including the virtual machine after termination of the use of the processor in operation S360 and the terminated processor is allocated to a virtual machine given a priority in the waiting list in operation S370.

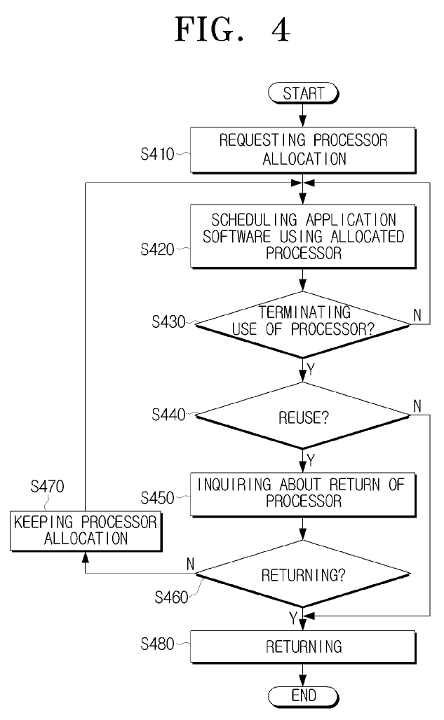

FIG. 4 is a flowchart illustrating a method of managing processor resources of a virtual machine according to another embodiment of the present invention. Referring to FIG. 4, a virtual machine requests a virtual machine monitor to allocate a processor if a software application or component of the virtual machine is to be executed in operation S410. More specifically, a software application or component within the virtual machine requests a corresponding guest operating system to allocate a processor for execution. Next, a processor scheduler under control of the guest operating system determines whether an additional processor is to be used. If the additional processor is to be used, the processor scheduler requests the virtual machine monitor to allocate a processor. The request may include preferred NUMA node information. In this case, since the request is made for allocation of a processor that is easy to access, time taken to make a request and time taken to respond to the request can be shortened.

Next, if an additional processor is allocated in response to the processor allocation request, the software application or component is scheduled using the allocated processor in operation S420. If the use of the processor to execute the software application or component terminates in operation S430, it is determined whether the virtual machine reuses the processor in operation S440. If the virtual machine is to reuse the processor, the virtual machine inquires of the virtual machine monitor about whether the virtual machine should return the processor in operation S450. If the virtual machine terminates the use of the processor, the virtual machine returns the processor to the virtual machine monitor in operation S480.

If the virtual machine is requested by the virtual machine monitor to return the processor in operation S460, the virtual machine returns the terminated processor to be available for use in operation S480. If a response that allows a reuse of the processor is received in operation S460, the processor allocation is maintained in operation S470.

The virtual machine management system and the method for managing processor resources thereof according to aspects of the present invention defines an interface for allocation and return of a processor between a virtual machine 110, 120 and a virtual machine monitor 130, thereby dynamically allocating a dedicated processor and efficiently utilizing the processor resources.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of managing processor resources of a virtual machine monitor, the method comprising:
receiving a request, from at least one virtual machine, for allocation of a processor;
determining whether allocating the requested processor is possible; and
if determined that the allocating of the requested processor is not possible, creating a waiting list and dynamically allocating an obtained processor to a virtual machine, of the at least one virtual machine, according to the waiting list.

2. The method as claimed in claim 1, wherein the creating of the waiting list comprises:
if determined that the allocating of the processor is not possible, creating the waiting list for the at least one virtual machine that has requested the allocating based on a pre-set processor allocation priority order; and
requesting another virtual machine to return an occupied processor.

3. The method as claimed in claim 2, further comprising allocating the processor that has returned in response to the requesting to the virtual machine, of the at least one virtual machine, according to a priority of the created waiting list.

4. The method as claimed in claim 2, further comprising, if there is no response to the requesting for return of the occupied processor, terminating an allocation of the occupied processor and allocating the terminated processor to the virtual machine, of the at least one virtual machine, according to a priority of the created waiting list.

5. The method as claimed in claim 1, further comprising:
receiving an inquiry about a reusability of the allocated processor from the virtual machine;
if the processor is reusable, maintaining the allocating of the processor;
and if the processor is not reusable, requesting return of the processor.

6. The method as claimed in claim 5, further comprising, if the processor is returned, terminating a use of the processor and adding the virtual machine to the waiting list.

7. The method as claimed in claim 1, wherein the determining of whether the allocating is possible comprises determining whether the allocating of the process is possible according to a number of processors available, a number of processors currently occupied, and/or a number of total processors in a system.

8. A method of managing processor recourses of a virtual machine, the method comprising:
requesting a virtual machine monitor to allocate a processor;
scheduling a software application or component using the processor allocated by the requesting;
if use of the allocated processor terminates, determining whether to reuse the processor; and
if the reuse of the processor is determined, inquiring about whether the processor should be returned.

9. A virtual machine management system to manage processor resources, the virtual machine management system comprising:
at least one virtual machine to request a processor to drive a software application or component; and
a virtual machine monitor to determine whether allocating the requested processor is possible, to create a waiting list if the allocating of the requested processor is determined to not be possible, and to allocate an obtained processor to a virtual machine, of the at least one virtual machine, according to the waiting list.

10. The virtual machine management system as claimed in claim 9, wherein, if the allocating of the requested processor is determined to not be possible, the virtual machine monitor creates the waiting list of the at least one virtual machine that has requested the allocating, based on a pre-set processor allocation priority order.

11. The virtual machine management system as claimed in claim 10, wherein the virtual machine monitor requests another virtual machine to return an occupied processor and allocates the processor returned according to the request to the virtual machine according to a priority of the created waiting list.

12. The virtual machine management system as claimed in claim 9, wherein the virtual machine determines whether the allocated processor after termination of use is to be reused, and if the processor is to be reused, inquires of the virtual machine monitor about whether the processor is to be returned.

13. The virtual machine management system as claimed in claim 12, wherein, if the processor is to be returned, the virtual machine monitor terminates a use of the processor and adds the virtual machine to the waiting list.

14. The virtual machine management system as claimed in claim 9, wherein the virtual machine monitor determines whether the allocating of the requested processor is possible according to a number of processors, a number of processors currently occupied, and/or a number of total processors in the system.

15. The virtual machine management system as claimed in claim 9, wherein the processor is a dedicated processor.
